(19) United States
(12) Patent Application Publication
(10) Pub. No.: US 2013/0220372 A1
(43) Pub. Date: Aug. 29, 2013

(54) SURFACE PROTECTOR

(71) Applicant: Harold V. Lee, Enfield, CT (US)

(72) Inventor: Harold V. Lee, Enfield, CT (US)

(21) Appl. No.: 13/407,705

(22) Filed: Feb. 28, 2012

(51) Int. Cl. B08B 7/04; B32B 3/06

(52) U.S. Cl. 134/18; 428/33

(57) ABSTRACT

A surface protector fits about three sides of a tire to protect a surface, such as a driveway, from tire cleaner and tire drips or runoff during cleaning. The surface protector may be a two-piece design, with a first piece in an L-shape, fitting about a front (or rear) side of the tire and along the front of the tire. The second piece may be adjustably disposed with the first piece to fit about the rear side of the tire. When assembled, the surface protector covers the surface (driveway) along three sides of the tire.

### BACKGROUND OF THE INVENTION

The present invention relates to surface protectors and, more particularly, to a shield that protects a driveway or other surface when cleaning and/or shining tires.

Various cleaners are used to clean wheels and tires on vehicles. Often, these cleaners contain solvents or acids to dissolve dirt and oil. These cleaners may drip off the tire, falling on the ground below, such as a driveway. Also, overspray may also end up on the driveway. The cleaner may harm the driveway surface.

Surface protectors known in the art may only protect a portion of the surface, or may not be adaptable to fit around tires of various sizes (or with different air pressures, and, thus, different sizes of ground contact).

As can be seen, there is a need for an improved surface protector that fits snuggly around three sides of a tire to protect the surface below during tire cleaning.

### SUMMARY OF THE INVENTION

In one aspect of the present invention, a surface protector comprises an angled member adapted to fit along a front edge and a side edge of a tire; and a straight member, adapted to removably connect to the angled member and adapted to fit along a rear edge of a tire, wherein the surface protector covers three sides of a surface about a tire when assembled.

In another aspect of the present invention, a surface protector comprises an angled member adapted to fit along a front edge and a side edge of a tire; an alignment tab extending from the angled member; a straight member, adapted to removably connect to the angled member and adapted to fit along a rear edge of a tire; and an alignment slot formed into the straight member, the alignment slot configured to receive the alignment tab, wherein the surface protector covers three sides of a surface about a tire when assembled.

In a further aspect of the present invention, a method of protecting a surface from tire cleaner when cleaning a tire comprises placing an angled member along a front and outer side edge of the tire; removably connecting an straight member onto the angled member so that the straight member is disposed along a rear edge of the tire; and applying tire cleaner to the tire, where the angled member and the straight members are disposed to catch drips and overspray of the tire cleaner.

These and other features, aspects and advantages of the present invention will become better understood with reference to the following drawings, description and claims.

### BRIEF DESCRIPTION OF THE DRAWINGS

FIG. 1 is a perspective view of a surface protector, in use about a vehicle tire, according to an exemplary embodiment of the present invention;

FIG. 2 is a perspective view of the surface protector of FIG. 1, showing an application method;

FIG. 3 is an end view of an angled member of the surface protector of FIG. 1;

FIG. 4 is a top view of the angled member of FIG. 3;

FIG. 5 is a top view of a straight member of the surface protector of FIG. 1; and

FIG. 6 is an end view of the straight member of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a surface protector that may fit about three sides of a tire to protect a surface, such as a driveway, from tire cleaner and tire drips or runoff during cleaning. The surface protector may be a two-piece design, with a first piece in an L-shape, fitting about a front (or rear) side of the tire and along the front of the tire. The second piece may be adjustably disposed with the first piece to fit about the rear side of the tire. When assembled, the surface protector covers the surface (driveway) along three sides of the tire.

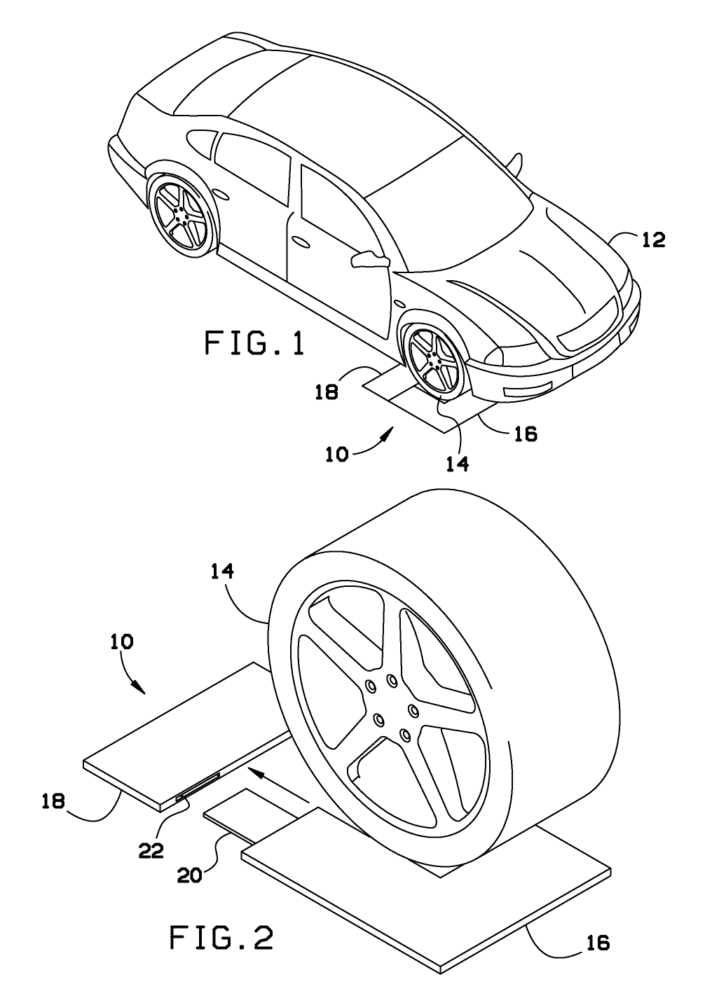

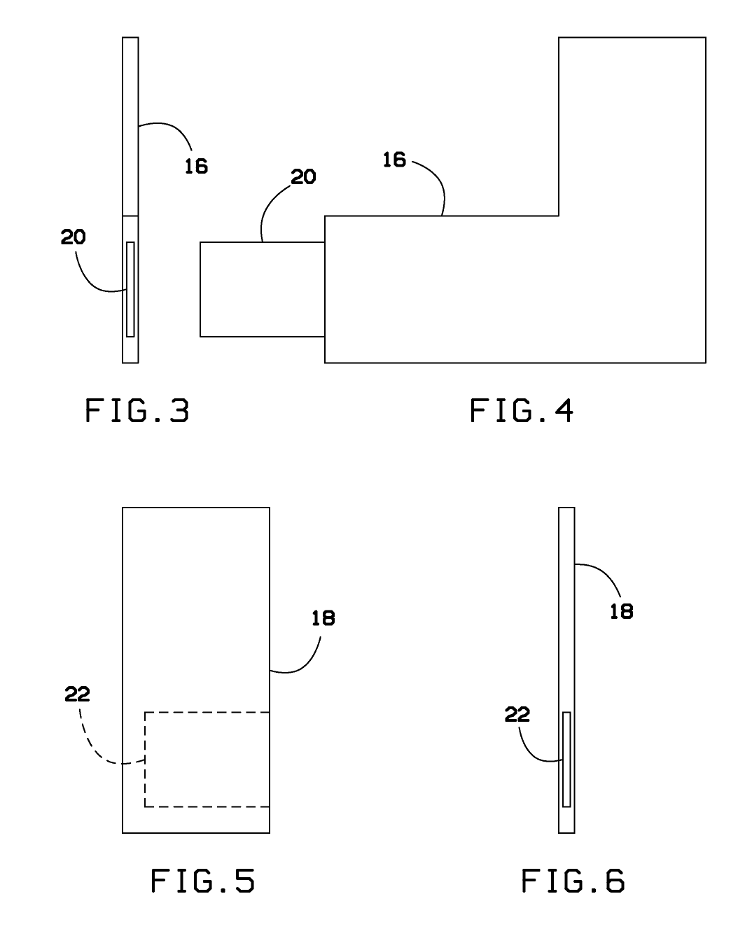

Referring now to FIGS. 1 through 6, a surface protector 10 may be designed to fit about three sides of a tire 14 of an vehicle, such as an automobile 12. The surface protector 10 may be assembled at the location of the tire, as shown in FIG. 2, to provide a close connection with the front and rear of the tire, as well as along the outside edge thereof.

The surface protector 10 may include an angled member 16 and a straight member 18. The angled member 16 may include an alignment tab 20 extending therefrom. The straight member 18 may include an alignment slot 22 adapted to receive the alignment tab 20. In some embodiments, the alignment tab 20 may extend from a central portion of the angled member 16, as shown in FIG. 4. In other embodiments, the alignment tab 20 may extend from an inside edge of the angled member 16. In this embodiment, if the straight member 18 does not fit all the way onto the alignment tab 20, then the portion of the alignment tab that is not inserted into the alignment slot 22 can act as a surface protector against the outer edge of the tire 14.

While the above paragraph describes the alignment tab 20 on the angled member 16 and the alignment slot 22 on the straight member 18, in some embodiments, the alignment tab 20 may be disposed on the straight member 18 while the alignment tab 22 may be disposed on the angled member 16.

The angled member 16 may be sized so that one side may be as long or longer than the width of the tire 14. The other side of the angled member 16 may be about as long as the amount of tire that touches the surface. In some embodiments, one side of the angled member 16 may be from about 4 to about 10 inches long, while the other side may be from about 4 to about 14 inches long, for example. The straight member 18 may be from about 6 to about 16 inches long, for example. The angled and straight members 16, 18 may have widths from about 2 to about 10 inches.

The surface protector 10 may be made from various materials, such as plastic, metal, composite, resin, and the like. Typically, the surface protector 10 may be made from a material that may not be readily damaged from the tire cleaner and tire runoff, such as plastic.

In some embodiments, the surface protector 10 may include a foam coating (not shown) on a top surface thereof. The foam coating may help with splashing from spraying and dripping once a cleaner has been applied to the tire. In some embodiments, the surface protector 10 may include a lip (not shown) running along the perimeter of the surface protector, extending away from the top surface thereof. The lip may help contain liquids caught by the surface protector 10 until they can be suitably disposed of in a proper container.

It should be understood, of course, that the foregoing relates to exemplary embodiments of the invention and that modifications may be made without departing from the spirit and scope of the invention as set forth in the following claims.

What is claimed is:

1. A surface protector comprising:
an angled member adapted to fit along a front edge and a side edge of a tire; and
a straight member, adapted to removably connect to the angled member and adapted to fit along a rear edge of a tire, wherein
the surface protector covers three sides of a surface about a tire when assembled.

2. The surface protector further comprising:
an alignment tab extending from the angled member; and
an alignment slot formed into the straight member, the alignment slot configured to receive the alignment tab.

3. The surface protector of claim 1, wherein the surface protector is made of plastic.

4. A surface protector comprising:
an angled member adapted to fit along a front edge and a side edge of a tire;
an alignment tab extending from the angled member;
a straight member, adapted to removably connect to the angled member and adapted to fit along a rear edge of a tire; and
an alignment slot formed into the straight member, the alignment slot configured to receive the alignment tab, wherein
the surface protector covers three sides of a surface about a tire when assembled.

5. The surface protector of claim 4, wherein the surface protector is made of plastic.

6. A method of protecting a surface from tire cleaner when cleaning a tire, the method comprising:
placing an angled member along a front and outer side edge of the tire;
removably connecting an straight member onto the angled member so that the straight member is disposed along a rear edge of the tire; and
applying tire cleaner to the tire, where the angled member and the straight members are disposed to catch drips and overspray of the tire cleaner.

7. The method of claim 6, further comprising sliding an alignment tab into an alignment slot to removably connect the straight and angled members.

8. The method of claim 7, wherein the angled member includes the alignment tab and the straight member includes the alignment slot.
